(19) United States
(12) Patent Application Publication
(10) Pub. No.: US 2015/0221904 A1
(43) Pub. Date: Aug. 6, 2015

(54) BATTERY MODULES AND CELLS WITH INSULATED MODULE BLOCK, AND METHOD FOR MANUFACTURING

(71) Applicant: GENERAL ELECTRIC COMPANY, SCHENECTADY, NY (US)

(72) Inventors: KRISTOPHER JOHN FRUTSCHY, CLIFTON PARK, NY (US); REZA SARRAFI-NOUR, CLIFTON PARK, NY (US); SANDOR ISTVAN HOLLO, MENANDS, NY (US); THOMAS ANGELIU, NISKAYUNA, NY (US); DONALD WAYNE WHISENHUNT, JR., NISKAYUNA, NY (US); DANIEL QI TAN, REXFORD, NY (US); SATISH GUNTURI, ALBANY, NY (US); ROGER NEIL BULL, NEEDWOOD (GB); JOHN RAYMOND KRAHN, SCHENECTADY, NY (US); DAVID CHARLES BOGDAN, JR., CHARLTON, NY (US)

(73) Assignee: GENERAL ELECTRIC COMPANY, SCHENECTADY, NY (US)

(21) Appl. No.: 14/172,015

(22) Filed: Feb. 4, 2014

(51) Int. Cl. H01M 2/10; H01M 10/6557; H01M 10/04; H01M 10/6554

(52) U.S. Cl. CPC H01M 2/1016; H01M 2/1094; H01M 10/5053; H01M 10/5059; H01M 10/04

(57) ABSTRACT

Systems and methods for providing the assembly electrochemical cells in neutral materials are described. Components can be eliminated from traditional electrochemical cell designs in this fashion. Embodiments of assemblies include a module block formed of a neutral material including a plurality of cell cavities, the cell cavities having at least an open top end. Each of the plurality of cell cavities is configured as a cell case for an electrochemical cell. The cavities can be provided a feed-through assembly, or have an electrochemical cell assembled therein.

### BACKGROUND

1. Technical Field

Embodiments of the subject matter disclosed herein relate to energy storage devices. Other embodiments relate to structures and materials for assembling energy storage devices.

2. Discussion of Art

Electrochemical cells are frequently used in batteries that provide power in a variety of environments. The electrochemical cells can be constructed for mobility and strength by being assembled in various structures. The materials in these structures are designed to support the function of the battery and resist degradation from the internal and external environments in which the systems operate. To such ends, a wide variety of materials and subcomponents can be used in construction of the systems.

To contain production cost and time, batteries can be redesigned to use fewer or less expensive components. However, alternative constructions must still provide or support at least the chemical, electrical, and thermal characteristics of the battery.

### BRIEF DESCRIPTION

In one embodiment, a battery module is provided. The battery module can comprise a module block formed of a neutral material including a plurality of cell cavities. The cell cavities having at least an open top end to accept components of the cell. The components include a plurality of separators configured to divide each cell cavity among the plurality of cell cavities into at least a first compartment and a second compartment, wherein each of said plurality of cell cavities is configured as a cell case for an electrochemical cell.

A further embodiment may provide a battery cell. The battery cell comprises a cell case formed of a neutral material including a central bore through at least a portion of said cell case and parallel to a length of said cell case, a cell header configured to engage said cell case by sealing said central bore, and first and second electrodes. The central bore defines a bore volume configured to retain an interior portion of an electrochemical cell. (The length may be a longest dimension of the cell case, such that a long axis of the central bore is parallel to the length.)

In still a further embodiment, method for manufacturing an electrochemical cell module block can be disclosed. The method can comprise providing a block of a first neutral material, forming at least one cavity in the block, installing one or more of an insulation portion and a heating element in the at least one cavity, installing at least one cell case of a second neutral material between the one or more of the insulation portion and the heating element, and inserting at least one first electrode coil in the cell case, wherein at least a portion of the first electrode coil is in contact with an interior wall of the cell case. The method further includes attaching at least one second electrode substantially centered inside a perimeter of the first electrode coil, wherein the second electrode does not contact the first electrode coil, filling at least a portion of the at least one cell case with at least one electrode chemistry, and sealing at least one header to the at least one cell case, wherein a portion of the second electrode passes through the header.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Reference is made to the accompanying drawings in which particular embodiments of the invention are illustrated as described in more detail in the description below, in which:

FIGS. 1A and 1B illustrate embodiments of module blocks for multi-cell batteries.

FIGS. 2A through 2I illustrate an electrochemical cell formed in a module block 210 in various states of assembly;

FIGS. 3A, 3B, and 3C, illustrate exploded diagrams of various feed-through assemblies;

FIGS. 4A and 4B illustrate other portions of cell assemblies for use in cell cases disclosed herein;

FIGS. 5A, 5B, and 5C illustrate various views of a feed-through cell;

FIGS. 6A and 6B, illustrate a system including an electrochemical cell assembled in a block;

FIG. 7 illustrates a multi-cell embodiment of a system including multiple electrochemical cells in a common module;

FIGS. 8A and 8B illustrate various views of a further battery embodiment including multiple electrochemical cells;

FIGS. 9A, 9B, and 9C illustrate cutaway views of modular battery cells in a block of neutral material;

FIG. 10 illustrates a methodology 1000 for manufacture of an electrochemical cell in a block of neutral material;

FIG. 11 illustrates an alternative methodology 1100 for assembling an electrochemical cell in a cell tube; and

FIG. 12 illustrates a two-dimensional cutout of a shim having integrated tabs for electrical connections for use with integrated current collectors.

### DETAILED DESCRIPTION

One or more embodiments of the invention relate to systems and methods providing electrochemical cells formed in neutral materials. By providing the electrochemical cells in such materials, robust cells can be provided that eliminate components traditionally found in such cells. For example, compared to traditional battery designs, metal cell cases and mica insulation can be eliminated, and simplified headers can be employed to improve procurement and manufacturing efficiencies.

A neutral material is a material that is at least nonreactive to a chemistry of a battery cell and resistant to degradation (either to the structure of the neutral material, or in terms of adverse effects to the battery chemistry or function) when exposed to the chemistry. For example, a neutral material for a sodium nickel battery can be resistant to corrosion, reaction, or other degradation when in contact with the components of such a battery. Neutral materials can also be electrically insulating to provide structure around electrical components without risking a short circuit, and/or be thermally conductive to provide structure around chemical components while supporting the required operating temperatures and/or evenly distribute a heat load. Particular neutral materials may also be selected for use based on their mechanical strength, permeability, ability to bond with other materials, or other qualities.

Neutral materials can include various types of glass, ceramics, and cements or mineral structures. Examples of such materials can include porcelain, borosilicate, foam glass, sodium vapor, proprietary glasses, alumina-based materials, 50% alumina, 95% alumina, alpha alumina, beta alumina, mullite, Forsterite, Dolomite, soapstone, gypsum cement, calcium aluminates, and other appropriate types. In specific embodiments, neutral materials can include plastics (for use with, e.g., lithium-ion chemistries, or lead acid chemistries)

In embodiments, proprietary materials such as Kovar®, Schott® specialty glasses, Pyrex®, Foamglas®, and Secar® cements can be utilized herein. When employed, proprietary materials need not exclusively be limited to neutral materials.

Neutral materials can be used to form a block module, cell case, cell housing, neutral module, or similarly termed components. Such aspects generally refer to portions configured to contain at least a portion of an electrochemical cell, and may be constructed or configured (e.g., molded, extruded, cast, assembled, machined, drilled) to facilitate operative coupling with an electrochemical cell or other component. More than one neutral material can be used in a single module, system, or embodiment without departing from the scope of the invention. Further, it is not necessary that the same neutral materials be used in different embodiments; indeed, chemical, thermal, and electrical characteristics and design of alternative embodiments may render a neutral material from one embodiment inappropriate in another.

Various techniques can be used to adhere, seal, bond, or combine elements herein. Welding, glass sealing (including glass-to-metal bonding), glass pinching, brazing (e.g., high temperature brazing, active brazing, others), soldering, adhesives or glues, mechanical connectors (e.g., clamps, screws, bolts) and other techniques can be used alone or in combination to achieve seals, bonds, and closures herein.

Battery cells can include a separator that divides the cells into multiple compartments. Specifically, an electrochemical separator can be provided to partition the anode and cathode portions of a battery cell. Such battery cells can include a solid electrolyte, which can be fixed in the cell through attachment to the cell header, cell walls, or other portions. In embodiments, the solid electrolyte can be a beta alumina ceramic.

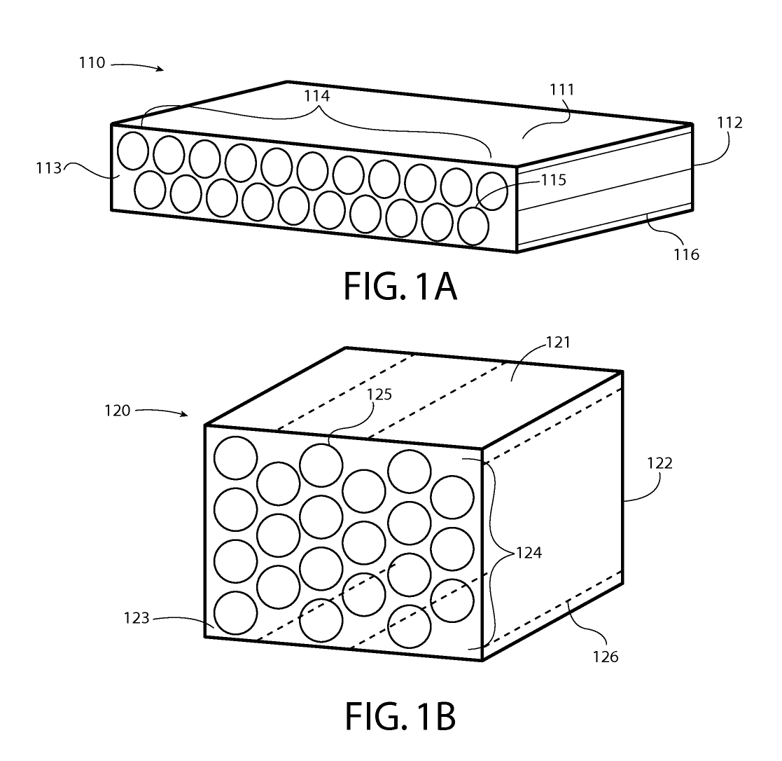

FIGS. 1A and 1B illustrate embodiments of module blocks 110 and 120. The module blocks are formed at least in part of a neutral material. In embodiments, the module blocks are formed as solid blocks of neutral material to have cavity groups 114 and 124 later-formed. In alternative embodiments, a module block is formed including the cavity group, and is substantially solid in portions other than the cavity group. Other embodiments can include forming the module blocks with some of the cavities, and later forming the remainder of the cavity group. In embodiments, additional modifications to the solid-block design can also be included, such as cooling channels or holes.

The module blocks 110, 120, which may have different geometries (e.g., different shapes, or the same shape but with different dimensions), have cells formed therein as one or more single cavities 115, 125, and/or others. While only one of the single cavities 115, 125 is labeled in FIGS. 1A and 1B, respectively, it is understood that these labels and accompanying description can apply to other cavities among the cavity group. In other words, each block may have plural of the cavities 114, 125, which together make up a cavity group 114, 124. Module block 110 can have a top 113, side(s) 111, and a bottom 112. Likewise, module block 120 can have a top 123, side(s) 121, and a bottom 122.

While the single cavities are illustrated as cylindrical bores through the module blocks, it is understood that the single cavities (and/or others) can be non-cylindrical in shape. Further, the plural cavities of a block can have the same shape and size, or different cavities among the cavity group within the module block can be of different shapes and sizes (e.g., in the block module some of the cavity group have rounded cross-section, others of cavity group have squared cross section). One or more cavities can be bored (or otherwise formed) to any depth in the module blocks, or bored (or otherwise formed) through the entirety of the neutral material.

The module blocks show respectively the cavity groups in the material. In different embodiments where pluralities of cells exist in the module blocks, the cells can be distributed uniformly or non-uniformly. For example, the groups of cavities are shown uniformly distributed and staggered in the illustrated embodiments. However, in alternative embodiments, cavities among the groups of cavities need not be staggered. In at least one alternative embodiment, cavities among the groups of cavities are not uniformly distributed. Further, embodiments can embrace only a portion of the groups of cavities being configured to have cells formed therein, or all of cavities can be configured to have cells formed therein but only a portion of the cavities will actually have cells formed therein.

The module blocks can include reinforcing members 116. While only one reinforcing member is labeled in FIG. 1A, it is understood that module blocks other than the one shown in FIG. 1A can have similar reinforcing member(s), and that aspects described can apply to a plurality of reinforcing members (e.g., any of the blocks may include one or more reinforcing members). Reinforcing members need not be identical in single embodiments. For example, a plurality of different reinforcing members can be included in the module block(s).

The reinforcing members perform one or more functions. The reinforcing members can serve to provide structural reinforcement or strength to the module blocks. In addition, reinforcing members may function as heating elements (e.g. joule heaters) when cavities contain electrochemical cells utilized with heating elements. Further, the reinforcing members may be thermally conductive to distribute a non-uniform heat load through the module blocks and/or cavities therein.

The reinforcing members pictured (and/or others) can be formed during formation of the module blocks. Alternatively, the reinforcing members can be inserted, attached, adhered, or constructed after formation of the module blocks.

Alternatively or complementarily, module blocks can include cooling passages 126. The cooling passages, where included, can be bores not interfering with the cavities that allow fluid to travel throughout the module block to distribute a thermal load and reduce “hot spots”.

In embodiments, one or more of the module blocks are monolithic, meaning that the neutral material that defines the cavities (some of the cavities, or all the cavities of the block) is a unitary and same piece of material. For example, a monolithic block with cavities can be formed by starting with a unitary piece of the neutral material and machining or otherwise forming the cavities into the unitary piece, or by casting the neutral material (e.g., in a molten or other liquid form, or powder form) into a mold that is shaped to establish the cavities and surrounding unitary structure of the neutral material.

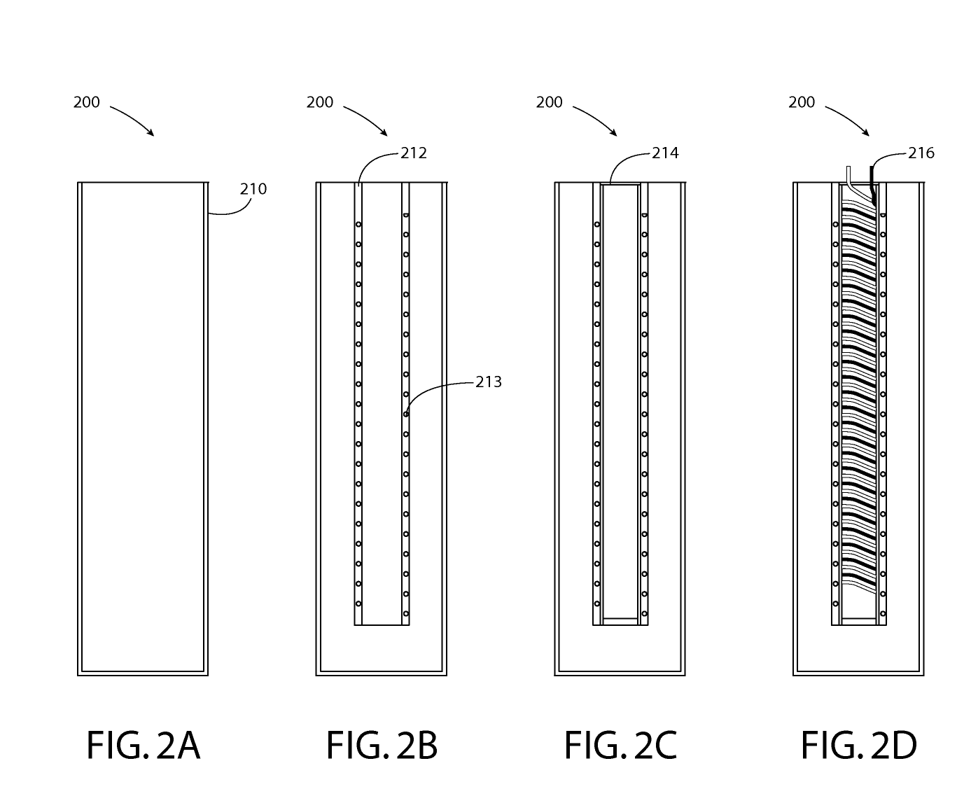

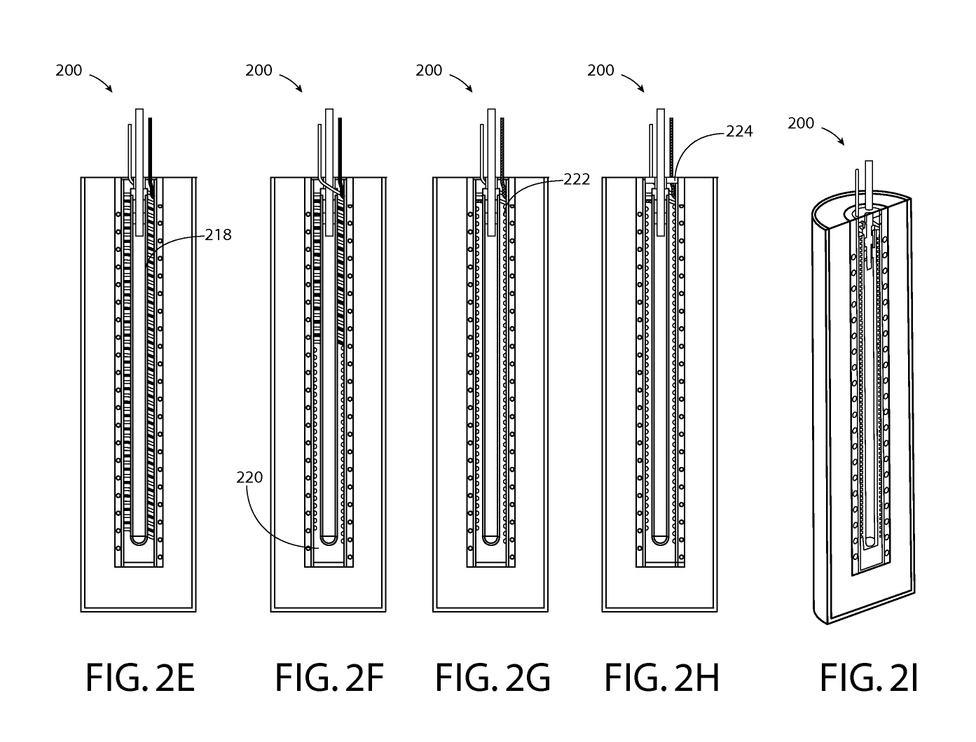

Turning now to FIGS. 2A through 2I, illustrated is an electrochemical cell 200 formed in a module block 210 in various states of assembly.

FIG. 2A depicts a single cell module block 210. In embodiments, the single cell module block can be a solid block of a neutral material, or a container or vessel formed at least in part of a neutral material. In embodiments where the single cell block module begins as a solid block of neutral material, a cavity can be formed in single cell module block to facilitate its integration with the other components of the electrochemical cell. (The module block of FIGS. 2A-2I may be a module block as shown in FIGS. 1A and 1B, e.g., the cavities of a module block as shown in FIG. 1A or 1B may be provided with electrochemical cells as described with respect to FIGS. 2A-2I.)

FIG. 2B shows a cavity formed in the single cell module block, with at least insulation 212 and heating elements 213 in the cavity. In embodiments, the insulation and the heating elements comprise a heater blanket. While FIG. 2B illustrates the heating elements, it will be appreciated, upon review of the disclosures herein in various embodiments and applications, that embodiments of the electrochemical cell need not include heating elements. Further, while the insulation is shown in a particular space in the illustrated embodiment of electrochemical cell 200, it is understood that insulation can fill the cavity of cell module block to its edges. In alternative embodiments, an air gap can be provided between the insulation and cell walls.

FIG. 2C shows the addition of a insulated cell case 214, the structure of which substantially matches the size of the cavity inside the insulating and the heating elements. The insulated cell case can be inserted and retained through use of a header or cap atop the single cell module block or a portion thereof (e.g., header or cap only covers cavity or the insulated cell case itself). Alternatively, various techniques relating to sealing or adhering can be employed to secure the insulated cell case in the single cell module block.

The insulated cell case serves to mechanically contain and fix the electrochemically active portions of the electrochemical cell in the cavity of the cell module block. The insulated cell case provides at least electrical insulation, and in specific embodiments can provide thermal insulation. Insulated cell cases in some embodiments are constructed of glass. In alternative embodiments, other materials can be used (e.g., ceramic, minerals, and others).

FIG. 2D illustrates the installation of an electrode wire coil 216. The outer diameter of the electrode wire coil can substantially match the inner diameter of the insulated cell case. Thus, the electrode wire coil can approximately fill the insulated cell case. In embodiments, the electrode wire coil does not go to the bottom of the insulated cell case. However, in alternative or complementary embodiments, the electrode wire coil extends approximately the length of the insulated cell case. One or more portions of the electrode wire coil can extend above the top of the insulated cell case. For example, the electrode wire coil can have the two free ends of the wire extend above the top of the insulated cell case. Like the insulated cell case in the single cell block module, the electrode wire coil can be retained in the insulated cell case by friction, a header or cap, or various sealing and adhering techniques.

In embodiments, the electrode wire coil is a cathode wire coil. In alternative embodiments, the electrode wire coil is an anode wire coil. The electrode wire coil can be formed of, for example, nickel, molybdenum, or other suitable materials.

FIG. 2E shows the installation of feed-through assembly 218. The feed-through assembly has a diameter substantially equal to or less than the inner diameter of the electrode wire coil. The feed-through assembly can include (or in its entirety function as) a second electrode. The feed-through assembly can be retained within the electrode wire coil by friction, through use of caps or headers, or by way of various adhering techniques.

In embodiments where the electrode wire coil is a cathode, the feed-through assembly can be an anode. However, aspects herein also embrace the feed-through assembly being a cathode where the electrode wire coil is an anode. In embodiments, the feed-through assembly includes the electrode wire coil, assembled together before installation, and FIGS. 2D and 2E are a single aspect of the installation.

FIG. 2F shows the addition of at least a portion of an electrochemical cell chemistry. (“Chemistry” in this instance refers to one or more materials that take part in, or otherwise support, the chemical operation of an electrochemical cell.) Granules 220 can be added to the insulated cell case. In a specific example, positive electrode granules can be added to the bottom of the insulated cell case. In embodiments, the insulated cell case can be a cathode compartment with the feed-through assembly being an anode, and in alternative embodiments, the insulated cell case can be an anode compartment with the feed-through assembly being a cathode. Depending on such configurations, other types of granules or chemicals can also be added.

FIG. 2G shows a further aspect of assembly where an electrolyte melt 222 is added to the insulated cell case. In embodiments, the heating elements or other components can be energized to bring at least a portion of the components (e.g., those inside the insulated cell case) to an elevated temperature prior to adding the electrolyte melt (or other cell chemistry).

FIG. 2H shows the addition of a top port 224 at least partially enclosing the insulated cell case and its contents. The top port can be configured to seal the insulated cell case, and seal to elements passing through the top port (e.g., electrode contacts).

Finally, FIG. 2I illustrates a cutaway view of a completed electrochemical cell 200 formed in the module block. As shown, the completed electrochemical cell within the module block can be cylindrical in embodiments. However, this is not intended to limit the possible geometries, and it is understood that the module block or other portions can be rectangular, elliptical, triangular, polygonal, and so forth.

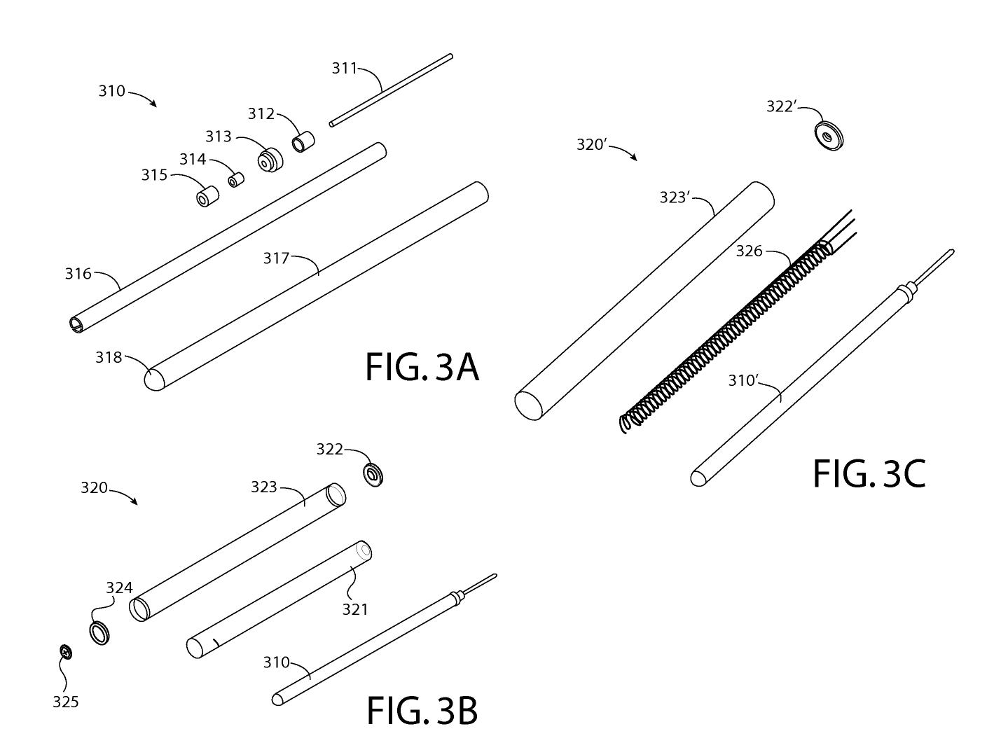

Turning now to FIGS. 3A, 3B, and 3C, illustrated are exploded diagrams 310, 320, and 320′ of various feed-through assemblies.

FIG. 3A illustrates feed-through electrode assembly 310. The feed-through electrode assembly can include an evacuation tube 311, a weldcan sleeve 312, an alumina insulator 313, an eyelet 314, and a metal adapter 315. At least a set of these components can be placed within or sealed to a metal shim 316. The metal shim can in turn be placed in an anode BASE (Beta Alumina Solid Electrolyte) 317. In embodiments, the anode base can be tapered, and include a rounded bottom 318.

While the foregoing describes FIG. 3A as having a feed-through anode assembly, it is understood that the feed-through electrode assembly can be a feed-through cathode assembly in alternative embodiments.

FIG. 3B illustrates an exploded view of cased feed-through assembly 320. The cased feed through assembly utilizes the feed-through electrode assembly (or other similar components) with a stopper contact 321 to install the electrical feed-through assembly within cell case 323. The cell case can be sealed at one end by a cell header 322, and enclosed at the other end by a fill port 324 and a closure cap 325.

FIG. 3C illustrates an alternative embodiment of an exploded view of cased feed-through assembly 320′. The cased feed through assembly utilizes the feed-through electrode assembly (or other similar components) with a stopper contact 321′ to install the electrical feed-through assembly within a cell case 323′. The cell case only includes one open end which can be sealed by a cell header 322′.

The cell cases described above can be formed of various materials. For example, the material of the cell cases may be glass as described in FIG. 2. However, it is also possible that the cell cases be formed in part or entirely of a ceramic (or other materials including metals) without departing from the scope or spirit of the invention. For example, an embodiment of a cell case can be an alumina tube, and the shim can be a copper shim. Cell headers may be formed from glass, ceramic, or other materials.

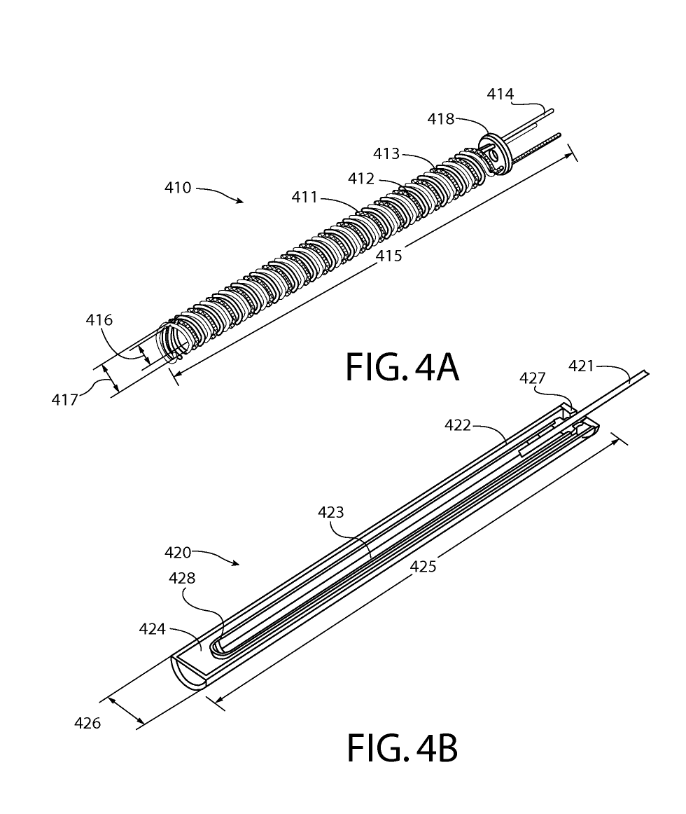

FIGS. 4A and 4B illustrate other portions of cell assemblies for use in cell cases disclosed herein. FIG. 4A illustrates an electrode coil assembly 410 including an outer electrode. The electrode coil assembly includes three windings 411, 412, and 413, which pass through a top port 418 exposing leads 414. The electrode coil assembly can have length 415, inner diameter 416, and outer diameter 417.

In embodiments, the windings can have a plurality of turns and a pitch. For example, the windings can have 19 turns at a 10 millimeter pitch. An example length can be 913 millimeters, including the leads extending outside the cell past the port. The wire can be, in various embodiments, nickel, clad copper (e.g., clad in a nickel-cobalt ferrous alloy compatible with the thermal expansion characteristics of glass), or other suitable materials.

Further, a cell case embodiment herein can have an outer diameter between 19 and 30 millimeters. Others can be larger or smaller. In embodiments, a multi-cell block holding three assemblies can be comprise a 50 by 50 by 250 millimeter block.

FIG. 4B illustrates cell assembly 420, including in cross section an illustration of an inner beta alumina tube 428, which can be used with the electrode coil assembly. The cell assembly can include a case 422, and an electrode base 423, from which at least lead 421 can extend through a cell cap 427. In embodiments, the cell cap can be the same header as seals the cell within a module block. In embodiments, the cell cap can be a separate component.

Cell assembly 420 can have length 425 and diameter 426. Bottom 424 of the cell assembly can be used to contain, for example, granules for the particular electrochemical cell.

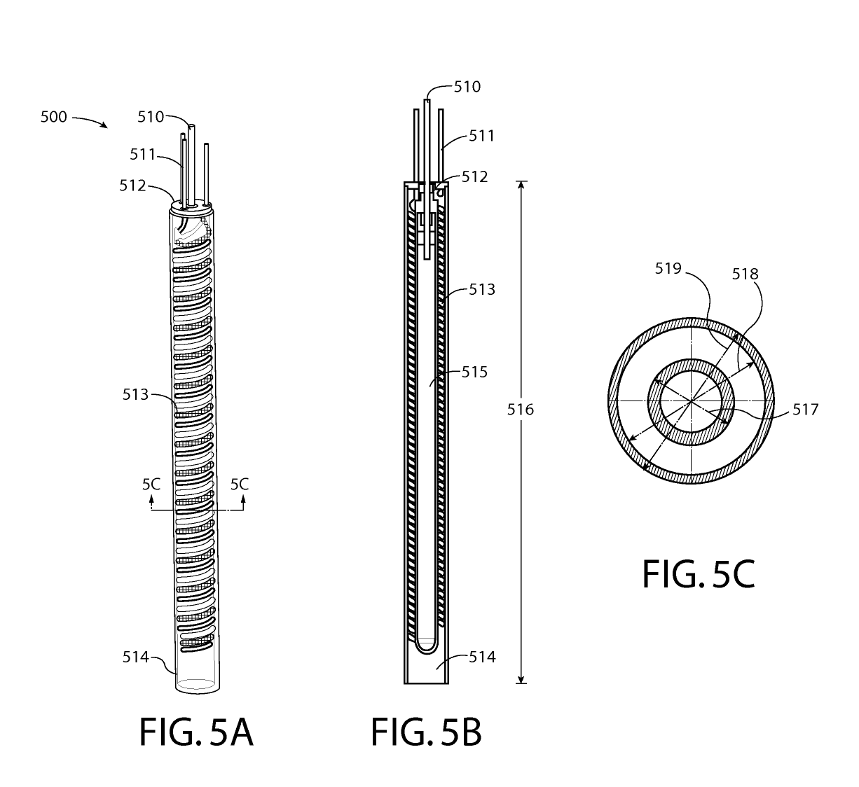

FIGS. 5A, 5B, and 5C illustrate various views of a feed-through cell 500. The feed-through cell can have an evacuation tube 510 from an inner electrode assembly 515, and leads 511 from a coiled electrode assembly 513. These and other components can be housed in a cell case 514, which can be enclosed using a cell cap 512 that allows at least the evacuation tube and electrode leads to pass through. The cell cap can be sealed to the cell, and the evacuation tube and electrode leads can be sealed to the respective portion of the cap through which they pass.

The feed-through cell has length 516, which is greater than the length of the electrode coils and inner electrode assembly. The diameter of the feed-through cell can be measured at various points. For example, in embodiments, the cell cap can have a diameter substantially coinciding with the diameter of the feed-through cell. as is visible in FIG. 5C, the cap has center diameter 517, through which the evacuation tube passes through at least a portion of. Further, the cap has an inner diameter 518 and outer diameter 519 defining an outer edge of the cap. The coiled electrode leads can pass through a portion of the cap farther from the center than the center diameter, but less than the inner diameter. Various sizes can be utilized. For example, the outer diameter can be 19-20 millimeters, the inner diameter can be 16-17 millimeters, and the center diameter can be 9-10 millimeters. In other embodiments, other sizes can be used.

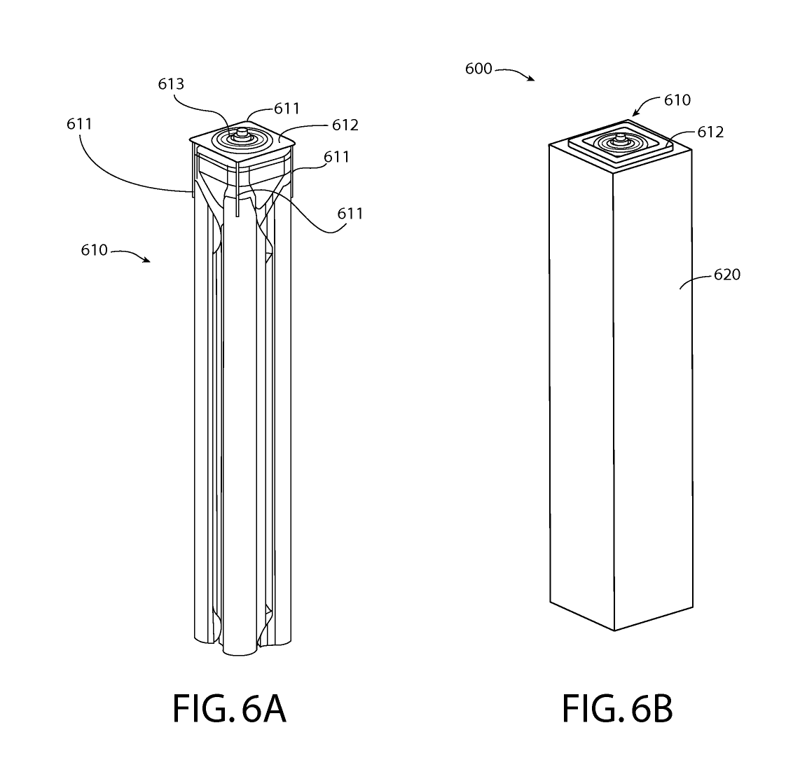

Turning now to FIGS. 6A and 6B, illustrated is a system 600 including an electrochemical cell 610 assembled in a block 620. The electrochemical cell includes a frame header 612. The frame header can have shims 611 at each corner to facilitate integration with the block. The frame header can mate with cell header 613. Alternatively, the frame header can be the cell header and simultaneously close the cell and seal it to the block.

In embodiments, various materials can be employed. The shims can be wire (e.g., American Wire Gauge size 18). The header frame can be made of, for example, a nickel-cobalt ferrous alloy compatible with the thermal expansion characteristics of borosilicate glass. The block can be formed of ceramic, glass, or another neutral material. The header can be sealed or adhered to two or more portions of the cell, the block, and/or other components using two or more techniques. For example, the header can welded to the cell, while brazed or glass sealed to the block.

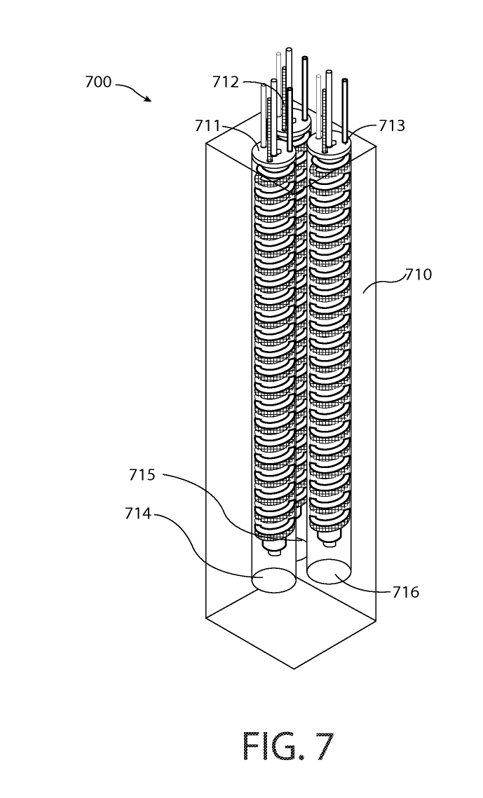

FIG. 7 illustrates a multi-cell embodiment of a system 700 including multiple electrochemical cells 711, 712, 713 in common module 710. In embodiments of the system, the electrochemical cells can be installed directly into cavities 714, 715, 716 within the module, such that the module itself serves as a cell case to each cell. Alternatively, a cell case can contain each electrochemical cell and be sized to be placed in the module. In embodiments, an additional header or frame (not pictured) can be placed around at least one side of the system, to secure or consolidate the leads extending above the cap of each respective cell. In alternative embodiments, a plurality of additional headers or frames can be placed over each respective cell within the module. In still further embodiments, no further header or frame is provided.

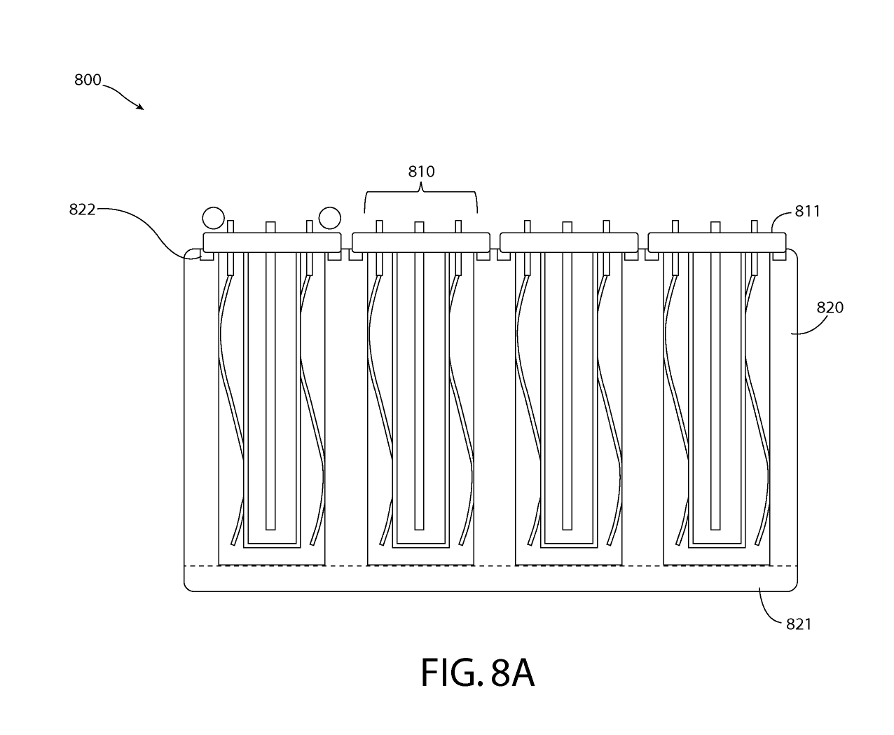

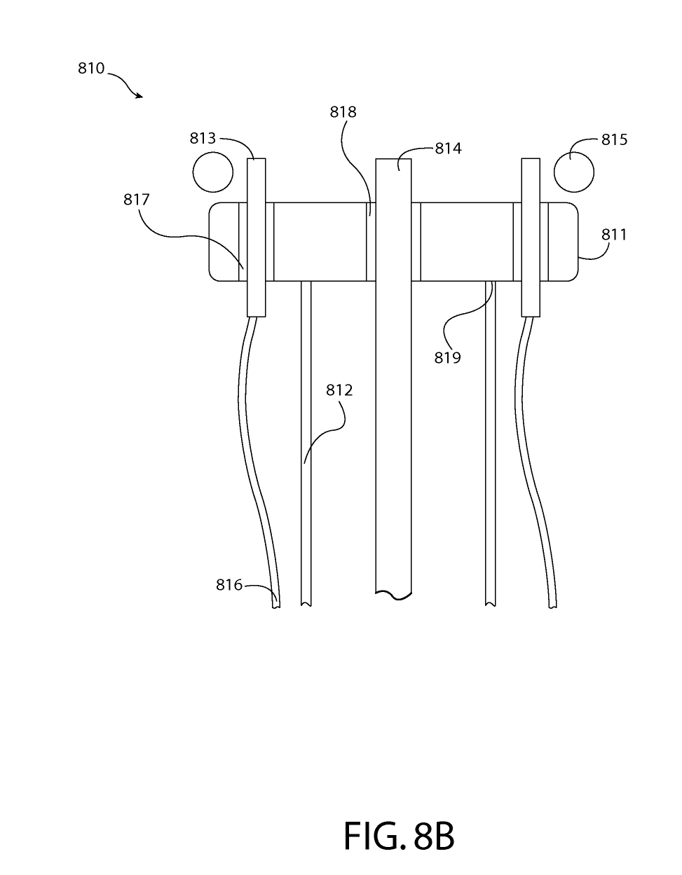

Depicted in FIG. 8A is another embodiment of a battery 800 including multiple electrochemical cells including electrochemical cell 810 in block 820. FIG. 8B shows at least a portion of one electrochemical cell at larger scale. The battery includes block 820 containing the cells. Headers 811 can secure the cells using a seal 822. In embodiments, the seal between the headers and the block can be a glass seal.

In embodiments, the battery includes bottom cap 821. For example, the cavities containing the cells can be bored through an entire block of material, such that both sides must be closed to contain the cell. In such embodiments, the bottom cap can close off the entire battery. In alternative embodiments, several bottom caps can be used to close each respective cell. In still further alternative embodiments, each cavity of the battery's block is only formed partially through the material, such that the bottom is closed off by the integral material.

FIG. 8B shows a portion of an electrochemical cell of the larger battery. The header is shown at the top. The cell includes first current collector 813, second current collector 814, heating coil 815, cell tube 812, and shim(s) 816.

The first current collector can be sealed to the header using a first seal 817. In embodiments, the first seal can be a high temperature braze. In embodiments, the first current collector can pass through the header at two or more locations, and each respective location can be sealed using at least the first seal.

The second current collector can be sealed to the header using second seal 818. In embodiments, the second seal can be a lower-temperature braze or active braze.

The header can be sealed to the block using various adhering techniques herein. In embodiments, the header can be ceramic or glass, and heated directly (e.g., with a torch) to bond the header to the block.

In embodiments, the cell tube is a beta alumina tube. It is understood that other materials can be used without departing from the scope or spirit of the innovation. The header can affix to the cell tube using tube-header seal 819. In embodiments, the tube-header seal is a glass seal.

The shim(s) can be a metal in contact with the first current collector. In particular embodiments, the shims can be a mild steel welded to the first current collector. It is understood that other materials can be used without departing from the scope or spirit of the innovation.

Either of the first and second current collector can be an anode or cathode current collector. Embodiments of the battery can utilize “anode-in” or “cathode-in” designs allowing alternative positioning of positive and negative electrodes.

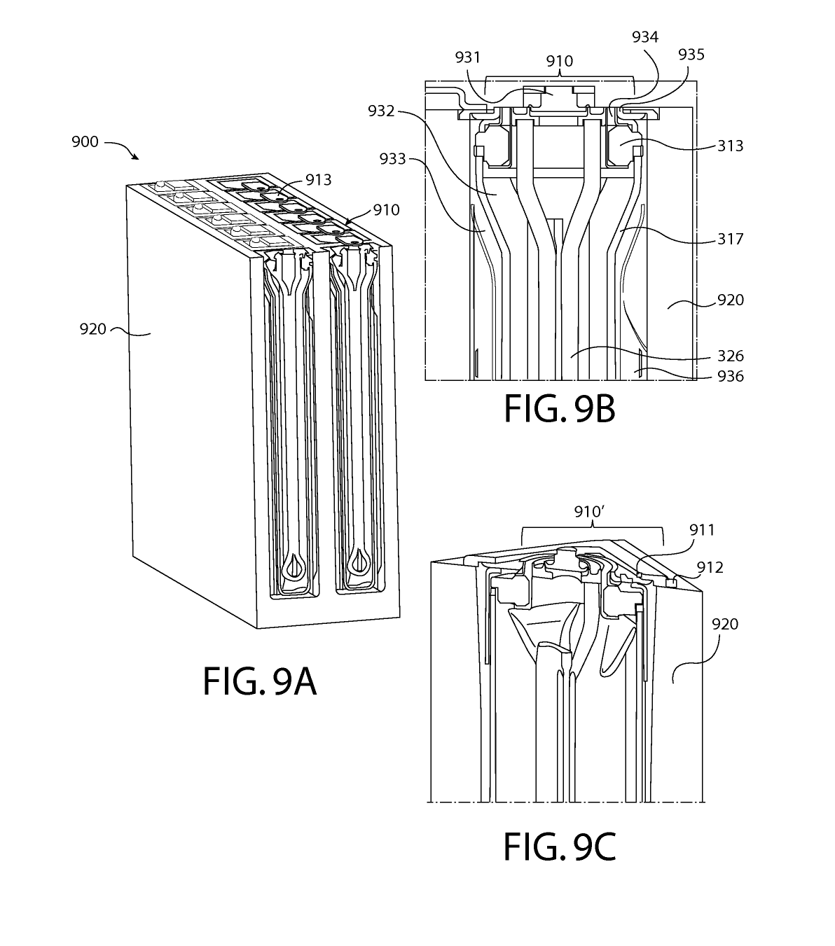

FIG. 9A and illustrates yet another embodiment of a battery 900 including cutaway views of multiple cells. Battery 900 includes module block 920, which can be a block of neutral material configured to accept one or more battery cells as described elsewhere herein.

FIG. 9A shows an inter-cell interface 913 (e.g., a bus bar or bus wire) providing electrical communication between cells. Details of an embodiment of a battery cell are visible. FIG. 9C illustrates an alternative embodiment including a frame that illustrates frame-cell seal 911 and frame-block seal 912. In embodiments, the frame-cell seal can be completed by welding, and the frame-block seal can be effected through brazing.

FIG. 9B provides a cutaway illustration of cell 910 at larger scale. Alumina insulator 313 and anode base 317 can be similar to those described elsewhere herein. Other aspects indicated include closure cap 931, cathode compartment 932, anode compartment 933, inner metal ring 934, outer metal ring 935, and metal shim 936.

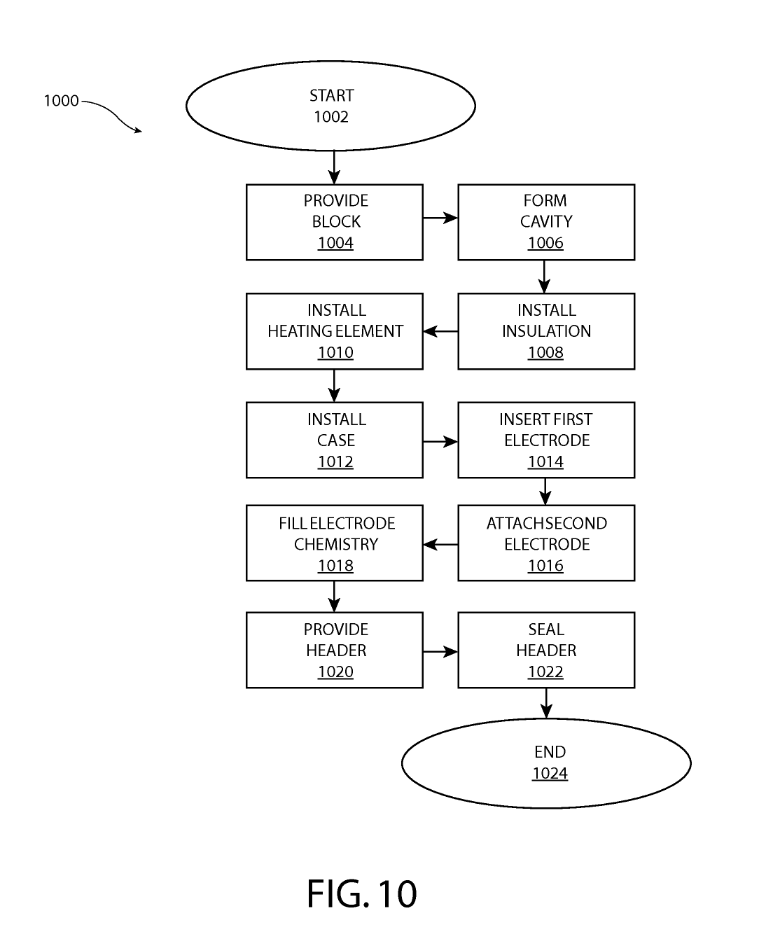

Turning to FIG. 10, illustrated is a methodology 1000 for manufacture of an electrochemical cell in a block of neutral material. Methodology 1000 begins at 1002 and proceeds to 1004 where a block of neutral material is provided. At 1006, a cavity can be formed in the neutral block that is sized for the components of an electrochemical cell and/or its feed-through assembly. In embodiments, the size of the cavity can further be based on space used by a blanket including insulation and heating elements outside a cell case.

With the cavity provided, at 1008 insulation can be installed, and at 1010 one or more heating elements can be installed. In embodiments, the insulation and heating element(s) can be combined outside the cavity and installed in a single action rather than sequentially. Further embodiments allow the order of installation of these or other components to be swapped.

At 1012, a cell case can be installed within the cavity, surrounded by the insulation and heating element(s). A first electrode can be inserted in the cell cavity at 1014, and a second electrode attached at 1016. Thereafter, respective chemical components (e.g., granules, electrolyte) can be provided to fill at least a portion of the cell case.

At 1020 a header can be provided, and electrodes or other portions of the electrochemical cell can be coupled with the header (e.g., passed through holes or ports). At 1022, the header can be sealed to the cell case and/or block, including sealing portions of the electrode to their respective ports. After sealing the header, the methodology proceeds to end at 1024.

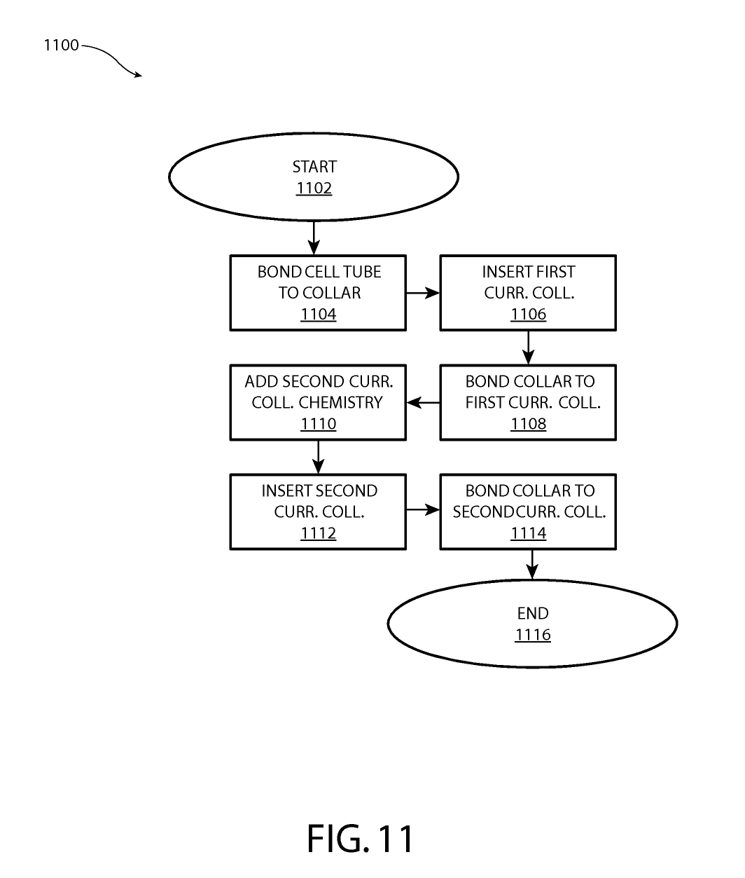

Turning now to FIG. 11, illustrated is an alternative methodology 1100 for assembling an electrochemical cell in a cell tube. For example, an electrochemical cell assembled in this fashion can be integrated with a block, or, in embodiments, the cell tube can include neutral portions to function as a standalone cell in accordance with aspects herein.

The methodology starts at 1102 and proceeds to 1104 where the cell tube is bound to a collar. In embodiments, the collar can be a cap or header for the cell tube. Thereafter, at 1106, a first current collector can be inserted through the collar into the cell tube. The first current collector and collar can be bonded at 1108 to secure the first current collector and seal the associated openings.

At 1110, cell chemistry (e.g., granules, electrolyte) can be added to the cell tube. In embodiments, the chemistry can be related to a second current collector. In embodiments, the cell chemistry can be added through an opening or port later plugged by another current collector other component, obviating the need for opening or closing other portions of the cell to add cell contents.

At 1112, a second current collector is inserted into the cell tube, and bonded to the collar at 1114. After the second current collector is secured to the collar, the cell is closed with the contents sealed therein. At 1116, the methodology ends.

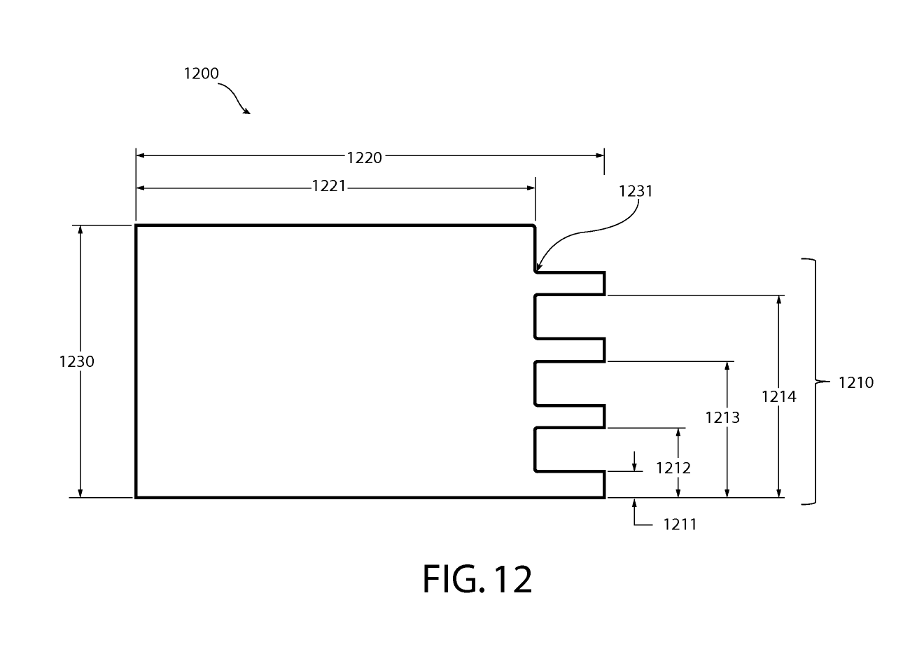

FIG. 12 illustrates a two-dimensional cutout of a shim 1200 having integrated tabs for electrical connections for use with integrated current collectors in cells herein. The tabs can contact the terminals of electrochemical cells. By pressing the cutout onto a cell tube, the shim can be shaped to provide electrical communication between contacts. The shim has a plurality of integrated tabs 1210. Widths 1211, 1212, 1213, 1214 define the width of each tab and distances therebetween, while width 1230 defines the entire cutout width. Radius 1231 can define a radius around each cut edge. Length 1220 is the total length of the shim, while length 1221 is the length of the shim body, in turn defining the length of the tabs. In embodiments, shim 1200 can be copper. In alternative or complementary embodiments, shim 1200 can be another metal or electrically conductive material.

The orientation or design of the shim can be modified to accommodate various neutral materials (e.g., alumina, foam glass, and others). Further, additional shims of the same or different materials can be used with shim 1200 to retain or fit the shim to an appropriate setting. For example, additional steel shims can be employed to press on a copper shim (1200) during or after installation.

An embodiment relates to a battery module comprising a module block, a plurality of separators, plural electrodes, a plurality of insulating cell headers, and a plurality of ports respectively through the plurality of insulating cell headers. The module block is formed of a neutral material and includes a plurality of cell cavities. The cell cavities have open top ends on a top side of the module block. The separators are configured to divide the cell cavities into at least respective first compartments and second compartments. Each of the cell cavities is configured as a cell case for a respective electrochemical cell. The insulating cell headers are configured to engage the module block by closing the plurality of cell cavities on the top side of the module block. A first electrode and a second electrode of the plural electrodes are configured to be housed at least in part by a first compartment and a second compartment of a first cell cavity of said plurality of cell cavities. The first electrode is an anode current collector, and the second electrode is a cathode current collector. At least one of the first electrode and/or the second electrode passes through one of the plurality of ports that is associated with one of the insulating cell headers that encloses the first cell cavity. (In another embodiment, the first electrode and/or the second electrode is sealed to the port by one of brazing, glass pinching, or glass sealing.)

In another embodiment, a battery cell comprises a cell case and a cell header. The cell case is formed of a neutral material including a central bore through at least a portion of the cell case and parallel to a length of said cell case. The cell header is configured to engage the cell case by sealing the central bore. The battery cell further comprises a first electrode and a second electrode. The central bore defines a bore volume configured to retain an interior portion of an electrochemical cell. The first electrode is an anode, and the second electrode is a cathode. The cathode is disposed as a rod centered in the cell case. The anode is disposed cylindrically about a perimeter of the cell case.

In another embodiment, a battery cell comprises a cell case and a cell header. The cell case is formed of a neutral material including a central bore through at least a portion of the cell case and parallel to a length of said cell case. The cell header is configured to engage the cell case by sealing the central bore. The battery cell further comprises a first electrode and a second electrode. The central bore defines a bore volume configured to retain an interior portion of an electrochemical cell. The first electrode is an anode, and the second electrode is a cathode. The anode is disposed as a rod centered in the cell case, and the cathode is disposed cylindrically about a perimeter of the cell case.

While various particular embodiments are described, it is appreciated that, unless expressly stated otherwise, the embodiments and details relating thereto are non-exclusive, non-exhaustive, and may be used in conjunction with other aspects herein without departing from the scope or spirit of the disclosure.

With reference to the drawings, like reference numerals designate identical or corresponding parts throughout the several views. However, the inclusion of like elements in different views does not mean a given embodiment necessarily includes such elements or that all embodiments of the invention include such elements.

In the specification and claims, reference will be made to a number of terms have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity may be expected, while in other circumstances the event or capacity may not occur—this distinction is captured by the terms “may” and “may be”.

The terms “including” and “having” are used as the plain language equivalents of the term “comprising”; the term “in which” is equivalent to “wherein.” Moreover, the terms “first,” “second,” “third,” “upper,” “lower,” “bottom,” “top,” etc. are used merely as labels, and are not intended to impose numerical or positional requirements on their objects. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims. In addition, references to “one embodiment” do not prevent aspects described from being included in other possible embodiments.

This written description uses examples to disclose the invention, including the best mode, and also to enable one of ordinary skill in the art to practice the invention, including making and using any devices or systems and performing any incorporated methods. The embodiments described herein are examples of articles, systems, and methods having elements corresponding to the elements of the invention recited in the claims. This written description may enable those of ordinary skill in the art to make and use embodiments having alternative elements that likewise correspond to the elements of the invention recited in the claims. The scope of the invention thus includes articles, systems and methods that do not differ from the literal language of the claims, and further includes other articles, systems and methods with insubstantial differences from the literal language of the claims. While only certain features and embodiments have been illustrated and described herein, many modifications and changes may occur to one of ordinary skill in the relevant art. The appended claims cover all such modifications and changes.

What is claimed is:

1. A battery module, comprising:
a module block formed of a neutral material and including a plurality of cell cavities, said plurality of cell cavities having open top ends on a top side of the module block; and
a plurality of separators configured to divide the cell cavities into at least respective first compartments and second compartments;
wherein each of said plurality of cell cavities is configured as a cell case for a respective electrochemical cell.

2. The battery module of claim 1, wherein the neutral material is electrically insulating and chemically inert.

3. The battery module of claim 2, wherein the neutral material is chemically inert to an anode chemistry.

4. The battery module of claim 2, wherein the neutral material is chemically inert to a cathode chemistry.

5. The battery module of claim 1, further comprising a plurality of insulating cell headers configured to engage said module block by closing said plurality of cell cavities on said top side of said module block.

6. The battery module of claim 5, further comprising plural electrodes, wherein a first electrode and a second electrode of the plural electrodes are configured to be housed at least in part by a first compartment and a second compartment of a first cell cavity of said plurality of cell cavities, wherein said first electrode is an anode current collector, and wherein said second electrode is a cathode current collector.

7. The battery module of claim 5, wherein the plurality of insulating cell headers are sealed to the module block to close the plurality of cell cavities by one of brazing, glass pinching, or glass sealing.

8. The battery module of claim 1, further comprising one or more reinforcing members at least partially spanning a portion of the battery module.

9. The battery module of claim 8, wherein said one or more reinforcing members are operative to at least one of structurally strengthen the battery module, heat at least a portion of the battery module, or conduct heat through the battery module.

10. The battery module of claim 1, further comprising an inter-cell interface placing at least two cell cavities among said plurality of cell cavities in electrical communication.

11. The battery module of claim 1, further comprising a plurality of cooling passages disposed at least partially between said plurality of cell cavities for fluid communication through at least a portion of said battery module.

12. A battery cell, comprising:
a cell case formed of a neutral material including a central bore through at least a portion of said cell case and parallel to a length of said cell case;
a cell header configured to engage said cell case by sealing said central bore;
a first electrode; and
a second electrode,
wherein said central bore defines a bore volume configured to retain an interior portion of an electrochemical cell.

13. The battery cell of claim 12, wherein a portion of the first electrode is coiled within the central bore.

14. The battery cell of claim 12, wherein said cell header engages the cell case through sealing, wherein the sealing is one of by brazing, glass pinching, or glass sealing.

15. The battery cell of claim 12, further comprising a feed-through assembly configured to pass a portion of at least the first electrode through the cell header.

16. The battery cell of claim 12, wherein the first electrode is an anode, and the second electrode is a cathode.

17. The battery cell of claim 12, wherein said neutral material is thermally conductive.

18. The battery cell of claim 12, further comprising a module block formed of the neutral material or a different neutral material, wherein the module block defines a cavity, and wherein the cell case is disposed in the cavity.

19. The battery cell of claim 18, further comprising:
a feed-through assembly configured to pass a portion of at least the first electrode through the cell header,
wherein the first electrode is an anode, and the second electrode is a cathode, wherein a portion of the first electrode is coiled within the central bore, and wherein said cell header engages the cell case through sealing, wherein the sealing is one of by brazing, glass pinching, or glass sealing.

20. A method for manufacturing an electrochemical cell module block, comprising:
providing a block of a first neutral material;
forming at least one cavity in the block;
installing one or more of an insulation portion or a heating element in the at least one cavity;
installing at least one cell case of a second neutral material between the one or more of the insulation portion or the heating element;
inserting at least one first electrode coil in the cell case, wherein at least a portion of the first electrode coil is in contact with an interior wall of the cell case;
attaching at least one second electrode substantially centered inside a perimeter of the first electrode coil, wherein the second electrode does not contact the first electrode coil;
filling at least a portion of the at least one cell case with at least one electrode chemistry; and
sealing at least one header to the at least one cell case, wherein a portion of the second electrode passes through the at least one header.
